(19) United States
(12) Patent Application Publication
(10) Pub. No.: US 2009/0016520 A1
(43) Pub. Date: Jan. 15, 2009

(54) APPARATUS, METHOD, COMPUTER PROGRAM PRODUCT, AND TERMINAL DEVICE FOR CONTROLLING COMMUNICATIONS

(75) Inventors: Koji Saiki, Tokyo (JP); Mitsuru Kanda, Tokyo (JP); Yasuyuki Kozakai, Kanagawa (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/168,409

(22) Filed: Jul. 7, 2008

(30) Foreign Application Priority Data
Jul. 6, 2007 (JP) 2007-178279

(51) Int. Cl. H04M 7/00

(52) U.S. Cl. 379/220.01

(57) ABSTRACT

A receiving unit receives from a second terminal, a switching request message requesting switching of a counterpart of a communication that a third terminal is establishing with a first terminal, from the first terminal to the second terminal. When receiving the switching request message, a selecting unit selects one of the second and third terminals based on a predetermined rule, as a transmission source terminal that transmits an establishment request message requesting establishment of a communication between the second terminal and the third terminal. A transmitting unit transmits to the transmission source terminal, a transmission request message requesting transmission of the establishment request message.

### CROSS-REFERENCE TO RELATED APPLICATIONS

This application is based upon and claims the benefit of priority from the prior Japanese Patent Application No. 2007-178279, filed on Jul. 6, 2007; the entire contents of which are incorporated herein by reference.

### BACKGROUND OF THE INVENTION

1. Field of the Invention

The present invention relates to an apparatus, a method, a computer program product, and a terminal device having a function of relaying a call control and switching between devices to be used for communications while maintaining a session.

2. Description of the Related Art

Recently, a session initiation protocol (SIP) has been widely known as a signaling procedure of controlling or relaying communications between communicating devices. An Internet protocol (IP) telephony system that achieves a telephone network on an IP network using the SIP is widespread.

In regard to the IP telephony system, JP-A 2006-174112 (KOKAI), proposes a technique of a call park service system. According to the call park service system, in a call park including plural terminals that are grouped, one of the terminals puts a call on hold, and another terminal releases the hold to switch between terminals to answer the call.

Meanwhile, the SIP also enables to transfer a call or switch between terminals by using a message called “REFER request”. The REFER request is a message requesting a call from an arbitrary party. A receiver of the REFER request calls an SIP uniform resource identifier (URI) that is specified in a “Refer-To” header of the REFER request by a transmitter of the REFER request. Because the REFER request can be used whether it is during a call or not, the REFER request is utilized to achieve transfer of a call, and the like.

Switching between terminals using the REFER request is implemented by the following two modes. According to one of the modes, a switching source terminal transmits to a call counterpart terminal, a REFER request specifying an SIP URI of a switching destination terminal in the “Refer-To” header. According to this mode, the counterpart terminal that receives the REFER request calls the switching destination terminal.

According to the other mode, the switching source terminal transmits to the switching destination terminal, a REFER request specifying an SIP URI of the counterpart terminal in the “Refer-To” header. According to this mode, the switching destination terminal that receives the REFER request calls the counterpart terminal.

According to either mode, whether to terminate a call between the switching source terminal and the counterpart terminal can be arbitrarily controlled when a call is established between the switching destination terminal and the counterpart terminal. For example, the mode can be adapted to terminate the call between the switching source terminal and the counterpart terminal. Alternatively, the call can be maintained according to data to be transmitted and received. In a case of data such as text chat and audio that cause no problem even when the data are simultaneously transmitted and received without terminating a call, the call can be maintained. Whether to maintain the call can be determined at the discretion of a user.

However, when the terminals are switched by the mode using the REFER request, a call for switching is initiated according to a request from a switching source terminal regardless of whether the switching source terminal is a caller or a receiver of an original call. Therefore, a terminal that should not normally be charged can be charged for the call.

For example, it is assumed that terminals are switched by the first switching mode when the switching source terminal initiates a call. In this case, the counterpart terminal calls for switching. Therefore, according to a charging system by which a caller of a call is charged, the counterpart terminal that is not normally charged can be charged.

Alternatively, it is assumed that terminals are switched by the second switching mode when the counterpart terminal initiates a call and the switching source terminal receives the call. In this case, because the switching destination terminal calls for switching, not the counterpart terminal that should be normally charged but the switching destination terminal can be charged.

The charging systems in switching between terminals depend on policies of providers. Therefore, the problems mentioned above might not occur. However, to address any charging systems, it is desirable that the provider can arbitrarily control the direction of a call at least at the switching.

The control of the direction of a call is not required when the system is configured only by an SIP proxy server that contains a switching source terminal. However, in a telephone network in which plural providers are mutually connected, charging from SIP proxy servers of other providers can occur. Therefore, the direction of a call needs to be controlled appropriately.

### SUMMARY OF THE INVENTION

According to one aspect of the present invention, a communication control apparatus that controls communications among plural terminals including first, second, and third terminals that are connected through a network, the apparatus includes a first receiving unit that receives from the second terminal, a switching request message requesting switching of a call counterpart of the third terminal that establishes a communication with the first terminal, from the first terminal to the second terminal; a selecting unit that selects one of the second terminal and the third terminal as a transmission source terminal that transmits an establishment request message requesting establishment of a communication between the second terminal and the third terminal, according to a predetermined rule, when receiving the switching request message; and a first transmitting unit that transmits to the transmission source terminal, a transmission request message requesting transmission of the establishment request message.

According to another aspect of the present invention, a communication control method executed in a communication control apparatus that controls communications among plural terminals including first, second, and third terminals that are connected through a network, the method includes receiving from the second terminal a switching request message requesting switching of a call counterpart of the third terminal that establishes a communication with the first terminal, from the first terminal to the second terminal; selecting one of the second terminal and the third terminal as a transmission source terminal that transmits an establishment request message requesting establishment of a communication between the second terminal and the third terminal, according to a predetermined rule, when receiving the switching request message; and transmitting to the transmission source terminal, a transmission request message requesting transmission of the establishment request message.

A computer program product according to still another aspect of the present invention causes a computer to perform the method according to the present invention.

According to still another aspect of the present invention, a terminal device that is connected to plural external terminals and a communication control apparatus for controlling communications among the external terminals through a network, the terminal device includes a receiving unit that receives from the communication control apparatus, communication information including a communication identifier for identifying a communication established among the external terminals and terminal identifiers for identifying the external terminals that are establishing the communication having the communication identifier, in association with each other; and a transmitting unit that transmits to the communication control apparatus, a switching request message requesting switching of one of the external terminals that are establishing the communication having the communication identifier selected by referring to the received communication information, to the terminal device.

### BRIEF DESCRIPTION OF THE DRAWINGS

FIG. 1 is a block diagram of a configuration of a communication system according to a first embodiment of the present invention;

FIG. 2 is a block diagram of a configuration of a call control server according to the first embodiment;

FIG. 3 is a schematic diagram for explaining an example of a data configuration of call information;

FIG. 4 is a schematic diagram for explaining an example of a data configuration of an identifier that is stored in an identifier storage unit;

FIG. 5 is a block diagram of a configuration of an SIP terminal according to the first embodiment;

FIG. 6 is a sequence diagram of an entire flow of a communication switching process according to the first embodiment;

FIG. 7 is a schematic diagram for explaining an example of a NOTIFY request to be transmitted;

FIG. 8 is a schematic diagram for explaining an example of a MESSAGE request;

FIG. 9 is a schematic diagram for explaining an example of a REFER request according to the first embodiment;

FIG. 10 is a sequence diagram of another example of the entire flow of the communication switching process according to the first embodiment;

FIG. 11 is a schematic diagram for explaining another example of the REFER request;

FIG. 12 is a schematic diagram for explaining an example of a SUBSCRIBE request;

FIG. 13 is a block diagram of a configuration of a call control server according to a second embodiment of the present invention;

FIG. 14 is a block diagram of a configuration of an SIP terminal according to the second embodiment;

FIG. 15 is a sequence diagram of an entire flow of a communication switching process according to the second embodiment;

FIG. 16 is a schematic diagram of an example of a REFER request according to the second embodiment;

FIG. 17 is a schematic diagram for explaining an example of an INVITE request;

FIG. 18 is a schematic diagram for explaining another example of the INVITE request; and

FIG. 19 is a schematic diagram for explaining a hardware configuration of a communication control apparatus according to the first or second embodiment.

### DETAILED DESCRIPTION OF THE INVENTION

Exemplary embodiments of an apparatus, a method, a computer program product, and a terminal device for controlling communications according to the present invention will be explained below in detail with reference to the accompanying drawings.

When switching between terminals using a REFER request of the SIP, a switching source terminal needs to specify an SIP URI of a switching destination terminal, as a destination (request URI) of a REFER request to be transmitted or a value of a “Refer-To” header. Therefore, different SIP URIs need to be assigned to the switching source terminal and the switching destination terminal.

Meanwhile, the SIP enables to assign one and the same SIR URI to plural terminals. In this case, the SIP proxy server simultaneously transfers a message to all the terminals to which the same SIP URI is assigned, or successively transfers a message to each of the terminals and receives a response therefrom.

Some SIP proxy servers transfer a message only to part of the terminals to which the same SIP URI is assigned, according to their own criteria. Thus, particularly when the same SIP URI is assigned to three or more terminals, transfer of a REFER request from a switching source terminal to a switching destination terminal cannot be assured.

According to a mode by which terminals to be used by users individually obtains accounts and different SIP URIs are assigned to the terminals thereby preventing such a problem and performing assured switching between terminals, loads to obtain and manage the accounts are unfavorably increased.

Therefore, a communication control apparatus according to a first embodiment of the present invention can control a terminal that initiates a communication for switching according to a predetermined rule. The communication control apparatus utilizes contact addresses that enable to uniquely identify terminals, so that a communication can be subjected to switching between terminals having the same Address-Of-Record (AOR) that is used as an SIP URI specified at the initiation of the communication.

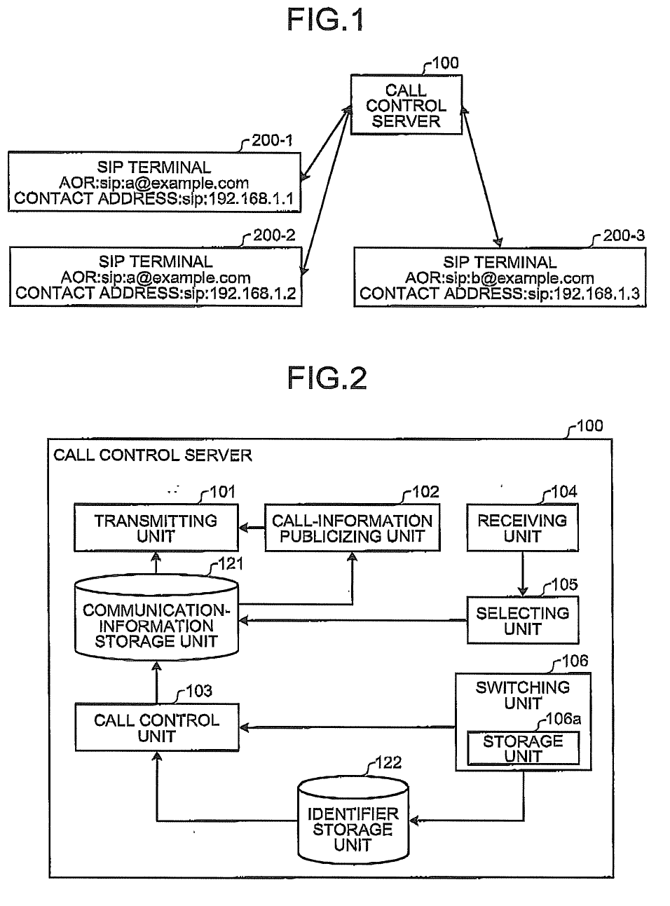

As shown in FIG. 1, a communication system according to the first embodiment includes a call control server 100 as a communication control apparatus, and plural SIP terminals 200 (an SIP terminal 200-1, an SIP terminal 200-2, and an SIP terminal 200-3), which are connected through an IP network.

To each of the SIP terminals 200, an AOR as a public identifier that is publicized to be specified as a destination when a communication is established, and a contact address as an internal identifier that uniquely identifies a terminal are assigned.

As shown in FIG. 1, according to the first embodiment, an AOR “sip.a@example.com” and a contact address “sip:192.168.1.1” are assigned to the SIP terminal 200-1. An AOR “sip:a@example.com” and a contact address “sip:192.168.1.2” are assigned to the SIP terminal 200-2. An AOR “sip:b@example.com” and a contact address “sip:192.168.1.3” are assigned to the SIP terminal 200-3.

The first embodiment assumes that the same AOR (sip:a@example.com) is assigned to the SIP terminals 200-1 and 200-2.

The number of the SIP terminals 200 is not limited to three. Any of the SIP terminals 200 can be connected through another call control server. The SIP terminals 200-1 to 200-3 are sometimes referred to simply as “SIP terminal 2001”, respectively.

A specific configuration of the call control server 100 is explained next. As shown in FIG. 2, the call control server 100 includes a communication-information storage unit 121, and an identifier storage unit 122, as main hardware components. The call control server 100 includes a transmitting unit 101, a call-information publicizing unit 102, a call control unit 103, a receiving unit 104, a selecting unit 105, and a switching unit 106, as main software components.

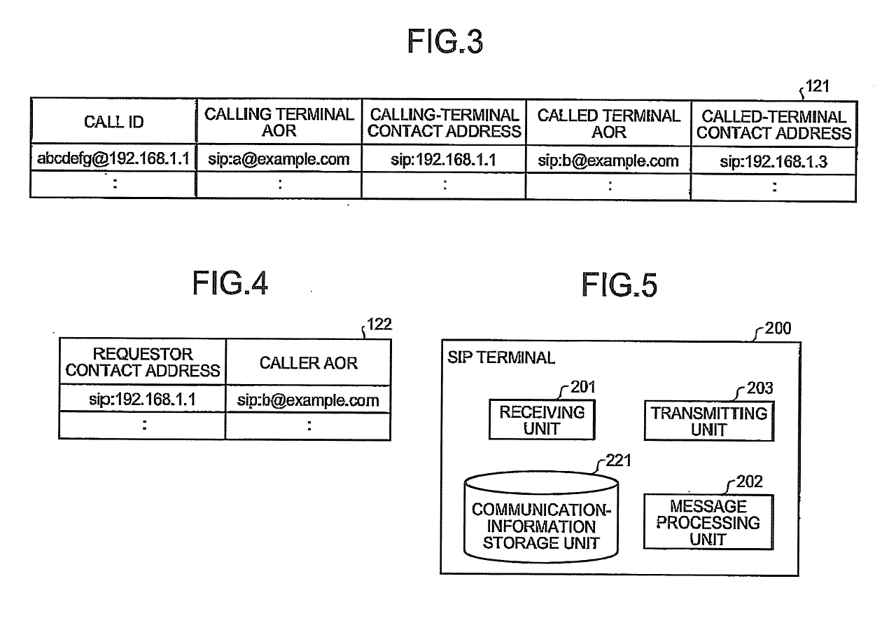

The communication-information storage unit 121 stores therein communication information associated with a communication established. A communication is hereinafter referred to as “a call”, and communication information is referred to as “call information”. As shown in FIG. 3, the call information includes a call ID as an identifier for identifying a call, a calling terminal AOR indicating a public identifier of the SIP terminal 200 that initiates a call, a calling-terminal contact address indicating an internal identifier of the SIP terminal 200 that initiates a call, a called terminal AOR indicating a public identifier of the SIP terminal 200 that initially receives the call, and a called-terminal contact address indicating an internal identifier of the SIP terminal 200 that initially receives the call. The communication-information storage unit 121 is referred to when the call information is searched for based on the call ID or the public identifier.

Returning to FIG. 2, the identifier storage unit 122 stores therein pairs of a public identifier and an internal identifier that are referred to, to identify a transfer destination to which an establishment request message requesting establishment of a call is to be transferred. As shown in FIG. 4, the identifier storage unit 122 stores therein a requester contact address indicating an internal identifier of the SIP terminal 200 that requests switching, and a caller AOR indicating a public identifier of the SIP terminal 200 that issues an INVITE request as an establishment request message of the SIP. The requester contact address and the caller AOR are related to each other.

The requester contact address is referred to, to identify the SIP terminal 200 to which the INVITE request issued by the SIP terminal 200 as the caller is to be transferred. More specifically, the identifier storage unit 122 is referred to when the contact address of the SIP terminal 200 as the transfer destination is searched for based on the caller AOR.

The communication-information storage unit 121 and the identifier storage unit 122 can be configured by any storage medium commonly used, such as a hard disk drive (HDD), an optical disk, a memory card, and a random access memory (R).

Returning to FIG. 2, the transmitting unit 101 transmits various messages associated with the call control to external devices such as the SIP terminals 200. For example, the transmitting unit 101 transmits a REFER request that is a transmission request message requesting start of transmission of an INVITE request, to the SIP terminal 200 as a caller selected by the selecting unit 105 (which is described below). The transmitting unit 101 transmits the INVITE request transmitted by the caller SIP terminal 200, to the SIP terminal 200 as a transfer destination.

Further, the transmitting unit 101 transmits a NOTIFY request for publicizing the call information, generated by the call-information publicizing unit 102 (which is described below) to each of the SIP terminals 200. More specifically, the transmitting unit 101 transmits the NOTIFY request to SIP terminals 200 associated with a call, that is, the SIP terminal 200 that initiates a call, the SIP terminal 200 having the same AOR as that of the SIP terminal 200 initiating the call, the SIP terminal 200 that initially receives the call, and the SIP terminal 200 having the same AOR as that of the SIP terminal 200 initially receiving the call.

The call-information publicizing unit 102 generates a NOTIFY request for publicizing the call information, and causes the transmitting unit 101 to transmit the NOTIFY request to each of the SIP terminals 200. The NOTIFY request includes all the call information stored in the communication-information storage unit 121. Details of the NOTIFY request are described below.

The call control unit 103 generally performs a process associated with control of calls according to standardized rules of the SIP. More specifically, the call control unit 103 controls a process of determining a destination to which a received call control message is to be transferred, based on details of the call control message, and transferring the call control message to the determined destination.

The call control unit 103 according to the first embodiment further includes a function of storing call information in the communication-information storage unit 121 when a call is established, and deleting the call information from the communication-information storage unit 121 when the call terminates. When receiving an INVITE request, the call control unit 103 uses an AOR of the SIP terminal 200 that is a transmitter of the INVITE request, as a retrieval key, to retrieve from the identifier storage unit 122, a contact address of the SIP terminal 200 to which the INVITE request is to be transferred. The call control unit 103 specifies the retrieved contact address to transfer the INVITE request. When the corresponding information is not stored in the identifier storage unit 122, the call control unit 103 determines the transfer destination based on the INVITE request.

The call control unit 103 according to the first embodiment further includes a function of, when receiving a MESSAGE request as a switching request message, generating a REFER request according to an instruction of the switching unit 106 (which is described below), and transmitting the REFER request to the SIP terminal 200 through the transmitting unit 101.

The receiving unit 104 receives various messages associated with the call control from external devices such as the SIP terminals 200. For example, the receiving unit 104 receives a MESSAGE request that is a switching request message requesting switching between communication destinations, and transmitted from the SIP terminal 200 as a switching destination terminal. The receiving unit 104 has a function of extracting a call ID of a call to be subjected to switching, from the received switching request message, and passing the extracted call ID and the AOR and contact address of the SIP terminal 200 that is a transmitter of the switching request message, to the selecting unit 105 (which is described below).

The selecting unit 105 selects either one of a switching mode by which an INVITE request is issued from a switching destination terminal and a switching mode by which an INVITE request is issued from a counterpart terminal, when the receiving unit 104 receives a switching request message.

The selecting unit 105 selects one of the two modes according to a rule previously determined by a provider of the call control server 100 or the like. For example, the rule can be set so that an INVITE request is issued from the SIP terminal 200 that initiates a call before switching. In this way, a calling terminal can be determined under a given policy, regardless of whether the SIP terminal 200 that initiates a call before switching or the SIP terminal 200 that receives a call before switching transmits a switching request message.

This is not the only rule according to which the switching mode is determined. Any rule can be applied as long as one of the two switching modes can be selected using the call information stored in the communication-information storage unit 121, or the like. Therefore, how to use the call information at the determination of the switching mode depends on the applied rule. According to the applied rule, the communication-information storage unit 121 can store therein information other than the information as shown in FIG. 3.

The selecting unit 105 has a function of referring to the communication-information storage unit 121 based on the call ID of a call that is to be subjected to switching, and the AOR and contact address of the SIP terminal 200 as the transmitter of the switching request message, which are passed from the receiving unit 104, and identifying a switching source terminal.

More specifically, the selecting unit 105 uses the given call ID as a retrieval key to retrieve the corresponding calling terminal AOR and called terminal AOR from the communication-information storage unit 121. The selecting unit 105 identifies one of the retrieved calling terminal AOR and called terminal AOR, matching the AOR of the SIP terminal 200 as the transmitter of the switching request message, as an AOR of a switching source terminal. The selecting unit 105 identifies the other AOR that does not match the AOR of the SIP terminal 200, as an AOR of the counterpart terminal.

The mode of identifying the switching source terminal is not limited to this. For example, the AORs of the SIP terminals 200 can be related to each other based on whether the SIP terminals 200 are used by the same user. One of the calling terminal AOR and the called terminal AOR, being related to the AOR of the SIP terminal 200 as the transmitter of the switching request message, can be identified as the AOR of the switching source terminal.

Alternatively, for example, the SIP terminal 200 that transmits the switching request message is authenticated, and whether the SIP terminal 200 is used by the same user is determined based on authentication information such as a user ID, thereby identifying the switching source terminal. An optimum mode of identifying the switching source terminal is selected according to an operation policy of the call control server 100.

Further, the selecting unit 105 can determine whether switching is possible according to the rule previously determined, before selecting the switching mode. For example, the selecting unit 105 can determine whether another call control server that relays a call for a counterpart SIP terminal 200 addresses a switching process. When the server does not address the switching process, the selecting unit 105 can reject switching. Alternatively, the selecting unit 105 can authenticate the SIP terminal 200 each time a message is transmitted or received. When the SIP terminal 200 is not authenticated, the selecting unit 105 can reject switching.

The switching unit 106 implements the switching mode selected by the selecting unit 105. For example, when the selecting unit 105 selects the switching mode by which a call is initiated from a switching destination terminal, the switching unit 106 requests the switching destination terminal to initiate a call for the counterpart terminal by using the call control unit 103.

Further, the switching unit 106 includes a storage unit 106a that stores an identifier in the identifier storage unit 122. For example, when the selecting unit 105 selects the switching mode by which a call is initiated from the counterpart terminal, the storage unit 106a stores an AOR of the SIP terminal 200 having a different AOR from that of the SIP terminal 200 that transmits a switching request message, among the SIP terminals 200 associated with a call to be subjected to switching, that is, an AOR of the counterpart terminal (caller AOR), and a contact address of the SIP terminal 200 that transmits the switching request message (requester contact address), in the identifier storage unit 122. The stored AOR and contact address are related to each other. The switching unit 106 then requests the counterpart terminal to initiate a call for the AOR of the SIP terminal 200 that transmits the switching request message, by using the call control unit 103.

A detailed configuration of the SIP terminal 200 is explained next. As shown in FIG. 5, the SIP terminal 200 includes a communication-information storage unit 221 as a main hardware component. The SIP terminal 200 includes a receiving unit 201, a message processing unit 202, and a transmitting unit 203, as main software components.

The communication-information storage unit 221 stores therein the call information transmitted from the call control server 100. Because the call control server 100 transmits a NOTIFY request for publicizing the call information as described above, the communication-information storage unit 221 stores therein the call information transmitted via the NOTIFY request. A data configuration of the call information stored in the communication-information storage unit 221 is the same as that of the call information stored in the communication-information storage unit 121 of the call control server 100. Therefore, explanations thereof will be omitted.

The receiving unit 201 receives various messages associated with the call control from external devices such as the call control server 100 and the other SIP terminals 200. For example, the receiving unit 201 receives the NOTIFY request for publicizing the call information transmitted from the call control server 100.

The message processing unit 202 executes processes associated with messages to be transmitted or received. For example, the message processing unit 202 obtains the call information from the NOTIFY request received to store the call information in the communication-information storage unit 221. The message processing unit 202 generates a switching request message (MESSAGE request) for a call that is selected by a user referring to the stored call information to switch a destination of the call to a terminal of the user. When receiving a REFER request from the call control server 100, the message processing unit 202 generates an INVITE request according to details of the REFER request.

The transmitting unit 203 transmits various messages associated with the call control to the external devices such as the call control server 100 and other SIP terminals 200. For example, the transmitting unit 203 transmits the generated switching request message to the call control server 100.

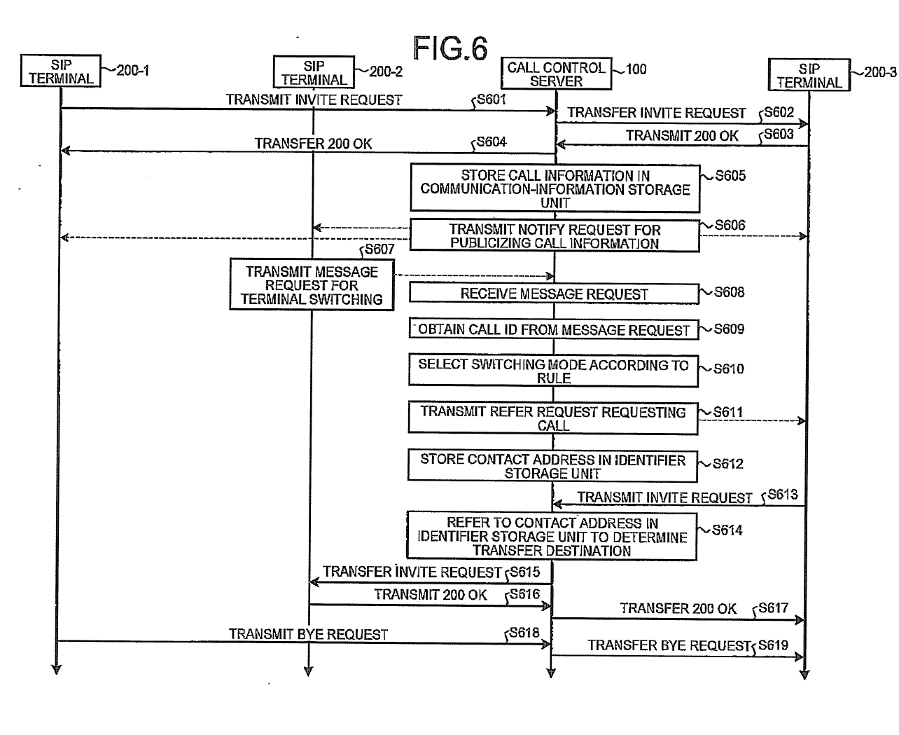

A communication switching process performed by the call control server 100 according to the first embodiment is explained next with reference to FIG. 6.

FIG. 6 depicts a process procedure performed when the SIP terminal 200-1 calls the SIP terminal 200-3 to establish a call, and the call is subjected to switching from the SIP terminal 200-1 to the SIP terminal 200-2 having the same AOR as that of the SIP terminal 200-1. It is assumed here that all of the SIP terminals 200 complete REGISTER operations specified by the SIP rules, and that the call control server 100 knows the AORs and contact addresses of all the SIP terminals 200.

The SIP terminal 200-1 first transmits an INVITE request “INVITE sip:b@example.com SIP/2.0” specifying “sip:b@example.com” as a request URI, to the call control server 100 (step S601).

The call control unit 103 of the call control server 100 then identifies a transfer destination as the SIP terminal 200-3 based on the request URI included in the INVITE request that is received by the receiving unit 104, and transfers the INVITE request (INVITE sip:b@192.168.1.3 SIP/2.0) to the SIP terminal 200-3 (step S602).

The SIP terminal 200-3 receives the INVITE request transferred from the call control server 100, generates a 200 OK response, and transmits the 200 OK response to the call control server 100 (step S603). The call control unit 103 of the call control server 100 that receives the 200 OK response transmitted from the SIP terminal 200-3 transfers the 200 OK response to the SIP terminal 200-1 (step S604). When the SIP terminal 200-1 receives the 200 OK response from the call control server 100, a call is established between the SIP terminal 200-1 and the SIP terminal 200-3.

Thereafter, the call control unit 103 stores call information in the communication-information storage unit 121 (step s605). The call information includes the AOR and the contact address of the SIP terminal 200-1, the AOR and the contact address of the SIP terminal 200-3, and a call ID included in the 200 OK response received from the SIP terminal 200-3, which are related to each other.

The call-information publicizing unit 102 then generates a NOTIFY request that contains the call information stored in the communication-information storage unit 121 in a message body, and transmits the NOTIFY request to all the SIP terminals 200 having the same public identifier as that of the SIP terminals 200 associated with the call through the transmitting unit 101 (step S606). In this example, the call-information publicizing unit 102 transmits the NOTIFY request to the SIP terminals 200-1, 200-2, and 200-3.

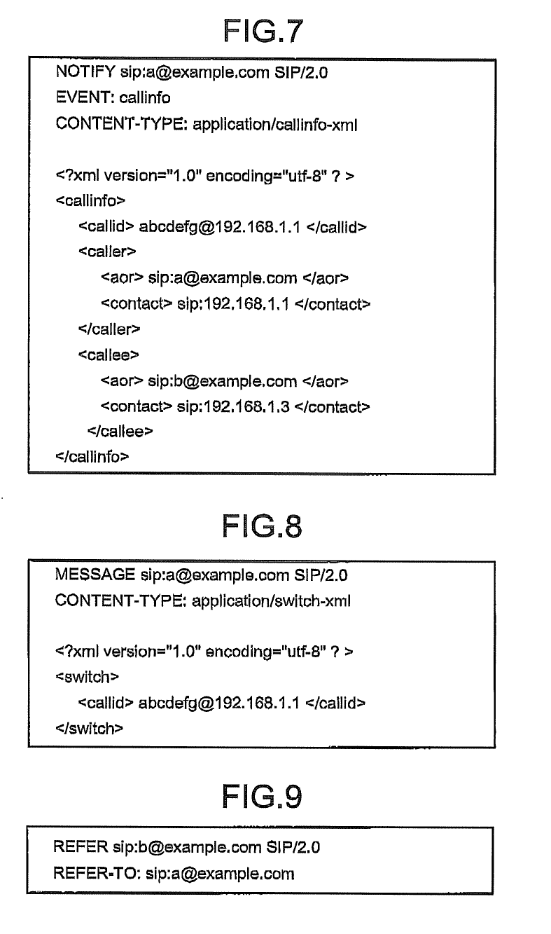

As shown in FIG. 7, “application/callinfo-xml” is specified in a “Content-Type” header of the NOTIFY request to specify that the request is a message for publicizing the call information. The NOTIFY request includes in the message body, the call information that is stored in the communication-information storage unit 121 and represented in a XML format. In FIG. 7, only one piece of call information is stored. When plural calls are established, the NOTIFY request can include plural pieces of call information.

Respective users of the SIP terminals 200 can specify a call to be subjected to terminal switching, by referring to the call information notified by the NOTIFY request. When a user of the SIP terminal 200-2 operates the SIP terminal 200-2 to select a call to be subjected to terminal switching, the message processing unit 202 of the SIP terminal 200-2 generates a switching request message (MESSAGE request) requesting terminal switching. The transmitting unit 203 transmits the generated MESSAGE request to the call control server 100 (step S607).

As shown in FIG. 8, a message body of the MESSAGE request includes the call ID included in the call information received by the NOTIFY request, as an identifier of the call to be subjected to switching. In the example shown in FIG. 8, the MESSAGE request includes the call ID “abcdedfg@192-168.1.1” of the call that is established between the SIP terminal 200-1 and the SIP terminal 200-3. In a “Content-Type” header of the MESSAGE request, “application/switch-xml” is specified to indicate the switching request message.

Returning to FIG. 6, the receiving unit 104 of the call control server 100 receives the MESSAGE request transmitted from the SIP terminal 200 (step S608). Because “application/switch-xml” is specified in the “Content-Type” header of the MESSAGE request, the receiving unit 104 determines that this is a switching request message. The receiving unit 104 obtains the call ID of the call to be subjected to the switching, from the message body of the MESSAGE request (step S609). The receiving unit 104 passes the call ID of the call to be subjected to the switching and the AOR and contact address of the SIP terminal 200 that transmits the MESSAGE request, to the selecting unit 105.

The selecting unit 105 selects one of the switching modes according to the policy specified by the provider of the call control server 100 (step S610). It is assumed that the selecting unit 105 selects the mode by which a call is initiated by the SIP terminal 200-3 that is a counterpart called by the SIP terminal 200-1.

In the case of a configuration that determines whether switching is possible, an error response can be returned to the received MESSAGE request when the switching is rejected.

The switching unit 106 causes the call control unit 103 to transmit a REFER request in which the AOR of the counterpart terminal is specified as a request URI, and the AOR of a switching destination terminal is specified in a “Refer-To” header, to the counterpart terminal. The call control unit 103 transmits the REFER request to the SIP terminal 200-3 as the counterpart terminal according to the instruction of the switching unit 106 (step S611).

FIG. 9 depicts an example of the REFER request in which “sip:b@example.com” as the AOR of the SIP terminal 200-3 is specified as the request URI, and “sip:a@example.com” as the AOR of the SIP terminal 200-2 is specified in the “Refer-To” header.

Returning to FIG. 6, the storage unit 106a of the switching unit 106 stores the contact address of the SIP terminal 200-2 that transmits the MESSAGE request and the AOR of the SIP terminal 200-3, which are related to each other, in the identifier storage unit 122 (step S612).

The SIP terminal 200-3 transmits an INVITE request “INVITE sip:a@example.com” in which “sip:a@example.com” as the AOR of the SIP terminal 200-2, included in the “Refer-To” header of the received REFER request is specified as the request URI, to the call control server 100 (step S613).

The receiving unit 104 of the call control server 100 receives the INVITE request transmitted from the SIP terminal 200-3. The call control unit 103 searches the identifier storage unit 122 for the contact address corresponding to the AOR (sip:b@example.com) of the SIP terminal 200-3 as the transmitter of the INVITE request, to determines a transfer destination of the INVITE request (step S614).

In this example, “sip:192.168.1.2”, which is the contact address of the SIP terminal 200-2, is obtained. The call control unit 103 transfers the INVITE request “INVITE sip.a@192.168.1.2” to the SIP terminal 200-2 having the obtained contact address (step S615).

The SIP terminal 200-2 that receives the INVITE request transmitted from the call control server 100 transmits a 200 OK response to the call control server 100 (step S616). The call control unit 103 of the call control server 100 transfers the 200 OK response transmitted from the SIP terminal 200-2, to the SIP terminal 200-3 (step S617).

The SIP terminal 200-3 receives the 200 OK response transferred from the call control server 100. Accordingly, a call is established between the SIP terminal 200-2 and the SIP terminal 200-3.

When a user of the SIP terminal 200-1 operates the SIP terminal 200-1 to specify an end of the call between the SIP terminal 200-1 and the SIP terminal 200-3, the transmitting unit 203 of the SIP terminal 200-1 transmits a BYE request “BYE sip:b@example.com” in which “sip:b@example.com” as the AOR of the SIP terminal 200-3 is specified as a request URI, to the call control server 100 (step S618).

The call control server 100 receives the BYE request transmitted from the SIP terminal 200-1, and transfers a BYE request “BYE sip:b@192.168.1.3” to the SIP terminal 200-3 that is identified as a transfer destination by referring to the request URI (step S619). The SIP terminal 200-3 receives the BYE request transmitted from the call control server 100, and disconnects the call with the SIP terminal 200-1.

As described above, when a switching request message requesting switching between communication terminals is received from one of the SIP terminals 200, one of the switching modes can be selected according to the operation policy. Even when the communication terminal switching is performed between the SIP terminals 200 having the same AOR assigned, a switching destination terminal can be correctly identified by storing the contact addresses that enable to uniquely identify the SIP terminals 200 and obtaining one of the stored contact addresses when an INVITE request is received.

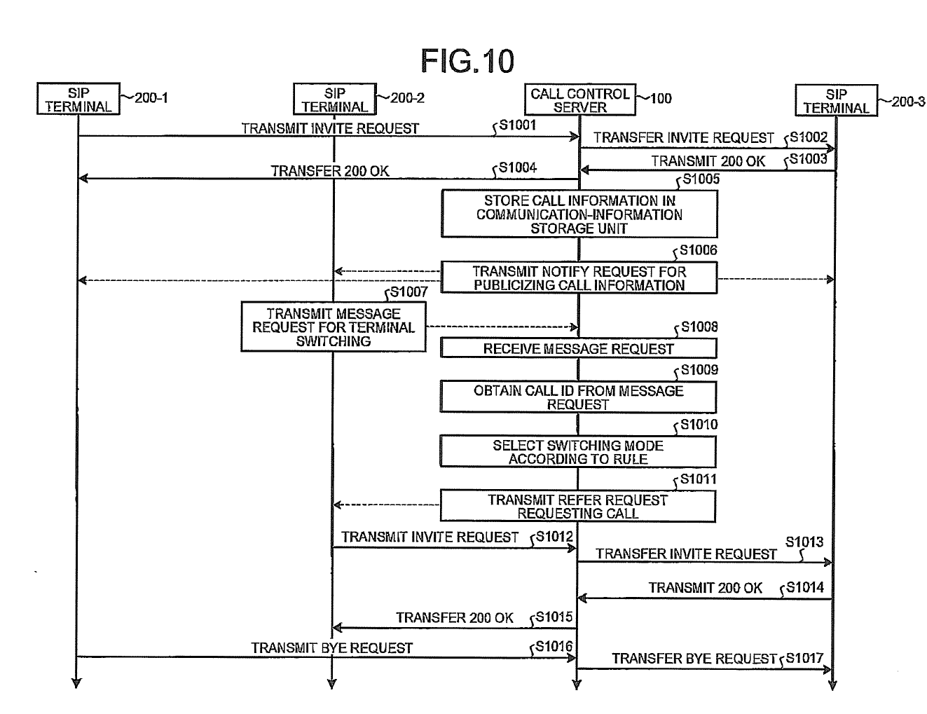

FIG. 6 depicts the process procedure performed when the switching mode by which the counterpart terminal (SIP terminal 200-3) initiates a call is selected. A process performed when the switching mode by which a switching destination terminal (SIP terminal 200-2) initiates a call is selected is explained next with reference to FIG. 10.

Processes from step S1001 to step S1010 performed until the switching mode is selected are the same as those from step S601 to step S610 in FIG. 6. Therefore, explanations of these processes will be omitted.

It is assumed that one of the modes is selected at step S1010, by which the SIP terminal 200-2 as a destination terminal to which the SIP terminal 200-1 is switched initiates a call.

In this example, the switching unit 106 causes the call control unit 103 to transmit a REFER request in which the AOR of the switching destination terminal is specified as the request URI, and the AOR of the counterpart terminal is specified in the “Refer-To” header, to the switching destination terminal. The call control unit 103 transmits the REFER request to the SIP terminal 200-2 as the switching destination terminal, according to the instruction of the switching unit 106 (step S1011).

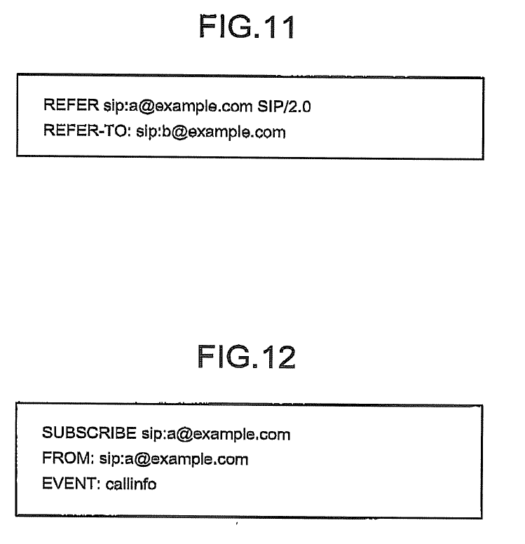

FIG. 11 is a schematic diagram for explaining another example of the REFER request transmitted in this example.

FIG. 11 depicts an example of the REFER request, in which “sip:a@example.com” as the AOR of the SIP terminal 200-2 is specified as the request URI, and “sip:b@example.com” as the AOR of the SIP terminal 200-3 is specified in the “Refer-To” header.

The SIP terminal 200-2 transmits an INVITE request “INVITE sip:b@example.com” in which the AOR “sip:b@example.com” of the SIP terminal 200-3, included in the “Refer-To” header of the received REFER request is specified as the request URI, to the call control server 100 (step S1012).

The receiving unit 104 of the call control server 100 receives the INVITE request transmitted from the SIP terminal 200-2. The call control unit 103 transfers the INVITE request “INVITE sip:b@192.168.1.3” to the SIP terminal 200-3 (step S1013). The contact address of the SIP terminal 200-3 can be identified from the call information stored in the communication-information storage unit 121 as shown in FIG. 3, for example.

The SIP terminal 200-3 that receives the INVITE request transmitted from the call control server 100 transmits a 200 OK response to the call control server 100 (step S1014). The call control unit 103 of the call control server 100 transfers the 200 OK response transmitted from the SIP terminal 200-3, to the SIP terminal 200-2 (step S1015).

The SIP terminal 200-2 receives the 200 OK response transferred from the call control server 100. Accordingly, a call is established between the SIP terminal 200-2 and the SIP terminal 200-3.

A call disconnecting process performed from step S1016 to step S1017 are the same as those at steps S618 and S619 in FIG. 6. Therefore, explanations of this process will be omitted.

According to the first embodiment, the call control server 100 that recognizes establishment of a call generates a NOTIFY request by itself, and notifies the SIP terminals 200 associated with the call of the call information. The SIP terminal 200 can inquire call information of the call control server 100.

In this case, the call-information publicizing unit 102 has a function of generating a NOTIFY request when receiving a SUBSCRIBE request that is an information request message requesting an inquiry about call information from the SIP terminal 200.

A procedure performed by the SIP terminal 200 to inquire call information of the call control server 100 is explained below. The SIP terminal 200 generates a SUBSCRIBE request for inquiring of the call control server 100 information of a call that is established by other SIP terminals 200 having the same AOR as that of the SIP terminal 200.

FIG. 12 is a schematic diagram for explaining an example of the SUBSCRIBE request for inquiring call information. As shown in FIG. 12, the SUBSCRIBE request has an “Event” header in which “callinfo” indicating an inquiry about call information is specified.

When receiving the SUBSCRIBE request transmitted from the SIP terminal 200, the call-information publicizing unit 102 of the call control server 100 recognizes that this is an inquiry about call information because “callinfo” is specified in the “Event” header of the SUBSCRIBE request.

Next, the call-information publicizing unit 102 obtains from a “From” header of the SUBSCRIBE request, an AOR of the SIP terminal 200 to which call information is to be returned. The call-information publicizing unit 102 then searches the communication-information storage unit 121 for call information including the obtained AOR, sets the retrieved cal information in the message body of the NOTIFY request, and notifies the SIP terminal 200 as the transmitter of the SUBSCRIBE request.

When the SIP terminal 200-2 transmits the SUBSCRIBE request during establishment of a call between the SIP terminal 200-1 and the SIP terminal 200-3, the NOTIFY request as shown in FIG. 7, for example, is transmitted from the call control server 100 to the SIP terminal 200-2.

As described above, in the communication system according to the first embodiment, the call control server can control a terminal that initiates a communication for switching according to a predetermined rule. Call information is publicized to terminals associated with the call, and switching is performed by a switching request message transmitted from a switching destination terminal. Accordingly, there is no need for a switching source terminal to specify a switching destination terminal to switch between terminals. When the switching request message is received from the switching destination terminal, the switching destination terminal can be identified based on a contact addresses that is stored to uniquely identify the switching destination terminal, even when the same AOR is assigned to the switching destination terminal and the switching source terminal.

Thus, the need to assign different AORs to the SIP terminals to enable the switching is eliminated, which reduces loads on managing accounts. Even when the same AOR is assigned to the switching destination terminal and the switching source terminal, the call control server can switch between communication terminals.

According to the first embodiment, the contact address of the switching destination terminal that transmits the switching request message and the AOR of the counterpart terminal are related to each other and stored in the identifier storage unit 122. The switching destination terminal is identified based on the contact address stored in the identifier storage unit 122.

On the contrary, a communication control apparatus according to a second embodiment of the present invention inserts a “Referred-By” header specified by the SIP rules, into a REFER request to be transmitted to a counterpart terminal and an INVITE request to be transmitted from the counterpart terminal. The communication control apparatus identifies the switching destination terminal by referring to the contact address of the switching destination terminal, set in the header.

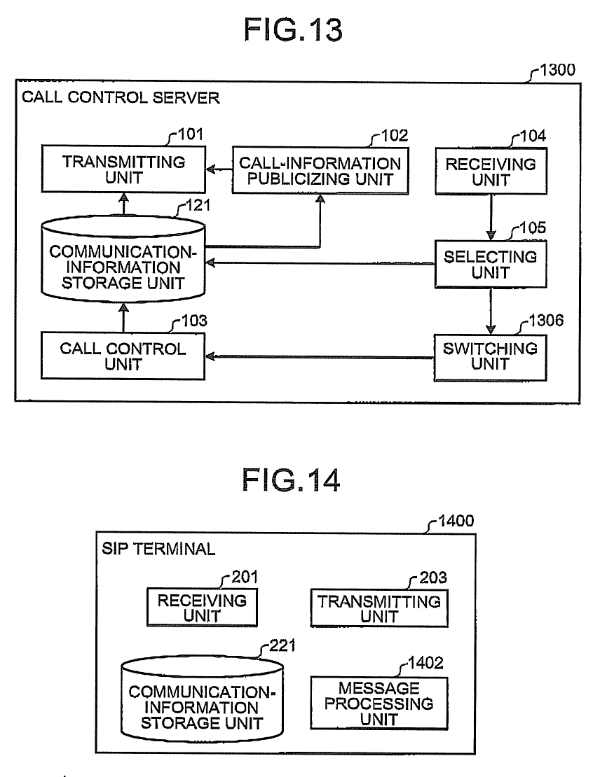

As shown in FIG. 13, a call control server 1300 includes the communication-information storage unit 121 as a main hardware component. The call control server 1300 includes the transmitting unit 101, the call-information publicizing unit 102, the call control unit 103, the receiving unit 104, the selecting unit 105, and a switching unit 1306, as main software components.

The second embodiment is different from the first embodiment in that the identifier storage unit 122 is eliminated, and in a function of the switching unit 1306. Other components and functions are the same as those shown in FIG. 2, which is the block diagram of the configuration of the call control server 100 according to the first embodiment. Therefore, like components are denoted by like reference numerals, and explanations thereof will be omitted.

The switching unit 1306 is different from the switching unit 106 according to the first embodiment in, when the selecting unit 105 selects one of the switching modes by which a counterpart terminal initiates a call, requesting a call to the counterpart terminal using a REFER request in which a contact address of a switching destination terminal is specified in the “Referred-By” header. There is no need to store the contact address and the like of the switching destination terminal in the identifier storage unit 122. Thus, the switching unit 1306 is different from the switching unit 106 according to the first embodiment in not including the storage unit 106a.

A detailed configuration of an SIP terminal 1400 according to the second embodiment is explained next. As shown in FIG. 14, the SIP terminal 1400 includes the communication-information storage unit 221 as a main hardware component. The SIP terminal 1400 includes the receiving unit 201, a message processing unit 1402, and the transmitting unit 203, as main software components.

A function of the message processing unit 1402 according to the second embodiment is different from that of the first embodiment. Other components and functions are the same as those shown in FIG. 5, which is the block diagram of the configuration of the SIP terminal 200 according to the first embodiment. Therefore, like components are denoted by like reference numerals, and explanations thereof will be omitted.

The message processing unit 1402 is different from the message processing unit 202 according to the first embodiment in, when receiving a REFER request in which a contact address of a switching destination terminal is specified in the “Referred-By” header, generating an INVITE request in which the “Referred-By” header extracted from the received REFER request is copied.

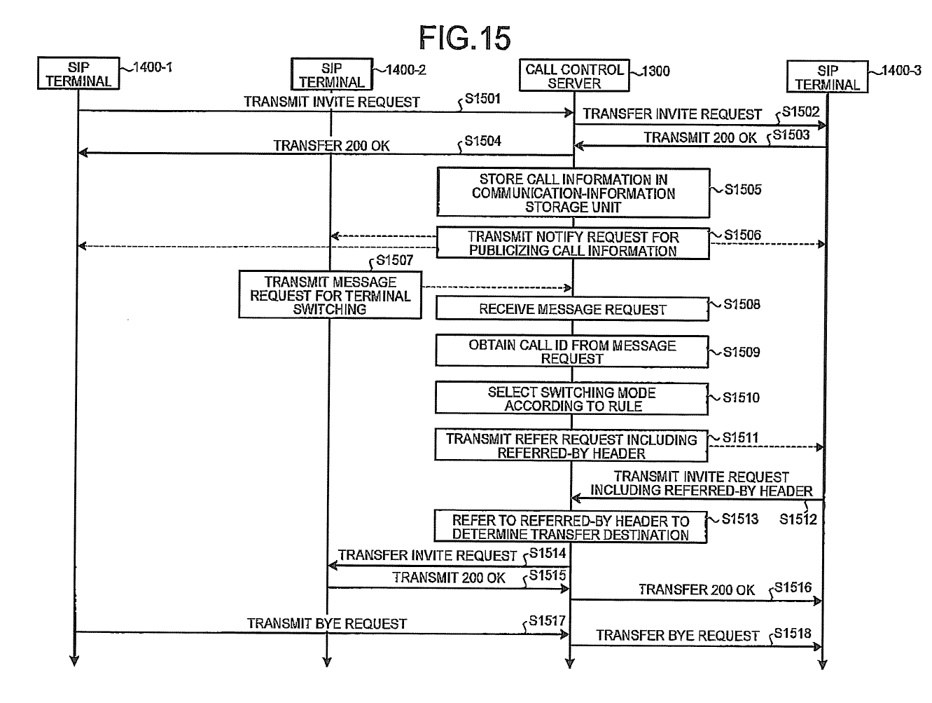

A communication switching process performed by the call control server 1300 according to the second embodiment is explained next with reference to FIG. 15.

FIG. 15 depicts a process procedure performed when an SIP terminal 1400-1 calls an SIP terminal 1400-3 to establish a call, and the call is switched from the SIP terminal 1400-1 to an SIP terminal 1400-2 having the same AOR as that of the SIP terminal 1400-1, like in FIG. 6. It is assumed that the same AORs and contact addresses as those of the SIP terminals 200-1 to 200-3 according to the first embodiment are assigned to the SIP terminals 1400-1 to 1400-3, respectively.

Processes from step S1501 to step S1510 performed until one of the switching modes is selected are the same as those from step S601 to step S610 in FIG. 6. Therefore, explanations of these processes will be omitted.

It is assumed here that the mode by which the SIP terminal 1400-3 that is a counterpart terminal called by the SIP terminal 1400-1 initiates a call is selected at step S1510.

In this example, the switching unit 1306 causes the call control unit 103 to transmit a REFER request in which the AOR of the switching destination terminal is specified as a request URI, the AOR of the counterpart terminal is specified in the “Refer-To” header, and the contact address of the switching destination terminal is specified in the “Referred-By” header, to the counterpart terminal. The call control unit 103 transmits the REFER request to the SIP terminal 1400-3 as the counterpart terminal according to the instruction from the switching unit 1306 (step S1511).

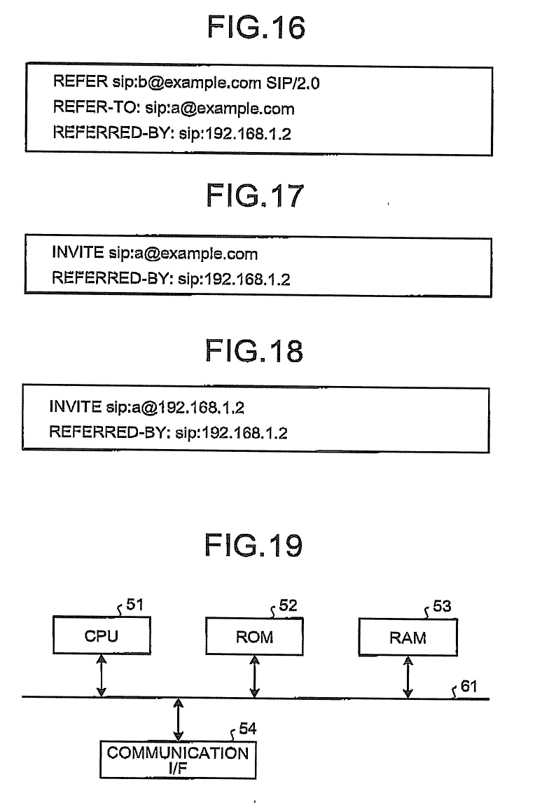

FIG. 16 depicts an example of the REFER request in which the AOR “sip:b@example.com” of the SIP terminal 1400-3 is specified as the request URI, the AOR “sip:a@example.com” of the SIP terminal 1400-2 is specified in the “Refer-To” header, and the contact address “sip:192.168.1.2” of the SIP terminal 1400-2 is specified in the “Referred-By” header.

Returning to FIG. 15, the SIP terminal 1400-3 transmits an INVITE request having a request URI specified as “sip:a@example.com”, which is the AOR of the SIP terminal 1400-2 and included in the “Refer-To” header of the received REFER request, to the call control server 1300 (step S1512). The SIP terminal 1400-3 copies contents of the “Referred-By” header of the received REFER request, to be included in the INVITE request.

FIG. 17 is a schematic diagram for explaining an example of the INVITE request including the “Referred-By” header. FIG. 17 depicts an example of the INVITE request including the “Referred-By” header having the same contents as those in the REFER request as shown in FIG. 16.

The receiving unit 104 of the call control server 1300 receives the INVITE request transmitted from the SIP terminal 1400-3. The call control unit 103 determines a transfer destination of the INVITE request by referring to the “Referred-By” header of the received INVITE request (step S1513).

In this example, “sip:192.168.1.2” as the contact address of the SIP terminal 1400-2 is obtained from the “Referred-By” header. The call control unit 103 transfers the INVITE request as shown in FIG. 18 to the SIP terminal 1400-2 having the obtained contact address (step S1514).

Processes of transmitting and receiving a 200 OK response and disconnecting a call from step S1515 to step S1518 are the same as those from step S616 to step S619 in FIG. 6. Therefore, explanations of these processes will be omitted.

As described above, the communication control apparatus according to the second embodiment can identify a switching destination terminal by adding a header in which a contact address of the switching destination terminal is set to a message and referring to the contact address of the switching destination terminal set in the header. More specifically, even when the same address is assigned to the switching destination terminal and a switching source terminal, the switching destination terminal can be identified based on the contact address stored. Thus, the need to assign different AORs to the SIP terminals to enable switching is eliminated, which reduces loads on managing accounts.

A hardware configuration of the communication control apparatus according to the first or second embodiment is explained next with reference to FIG. 19.

The communication control apparatus according to the first or second embodiment includes a control apparatus such as a central processing unit (CPU) 51, storage devices such as a read only memory (ROM) 52 and a RAM 53, a communication interface (I/F) 54 for connecting to a network to establish communications, and a bus 61. The bus 61 connects the respective components to an external storage device such as a HDD and a compact disc (CD) drive, a display device such as a display, and an input device such as a keyboard and a mouse. The communication control apparatus has a hardware configuration using a normal computer.

A communication control program executed by the communication control apparatus according to the first or second embodiment is provided being recorded in a file having an installable or executable format in a computer-readable recording medium such as a compact disk read only memory (CD-ROM), a flexible disk (FD), a compact disk recordable (CD-R), and a digital versatile disk (DVD).

The communication control program executed by the communication control apparatus according to the first or second embodiment can be stored in a computer that is connected to a network such as the Internet, and downloaded through the network. The communication control program executed by the communication control apparatus according to the first or second embodiment can be provided or distributed through a network such as the Internet.

Further, the communication control program according to the first or second embodiment can be stored in a ROM or the like in advance to be provided.

The communication control program executed by the communication control apparatus according to the first or second embodiment has a module configuration including the components mentioned above (the transmitting unit, the call-information publicizing unit, the call control unit, the receiving unit, the selecting unit, and the switching unit). As practical hardware, the CPU (processor) 51 reads the communication control program from the recording medium mentioned above to execute the program, so that the components mentioned above are loaded on a main storage, and the components are generated on the main storage.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication control apparatus that controls communications among plural terminals including first, second, and third terminals that are connected through a network, the apparatus comprising:
a first receiving unit that receives from the second terminal, a switching request message requesting switching of a call counterpart of the third terminal that establishes a communication with the first terminal, from the first terminal to the second terminal;
a selecting unit that selects one of the second terminal and the third terminal as a transmission source terminal that transmits an establishment request message requesting establishment of a communication between the second terminal and the third terminal, according to a predetermined rule, when receiving the switching request message; and
a first transmitting unit that transmits to the transmission source terminal, a transmission request message requesting transmission of the establishment request message.

2. The apparatus according to claim 1, wherein
a public identifier that is publicized as information for identifying a terminal to be connected and can be set so that the terminals have the same values, and an internal identifier that enables to uniquely identify a terminal are assigned to each of the terminals,
the communication control apparatus further comprises:
a second receiving unit that receives from the third terminal the establishment request message transmitted with the public identifier of the second terminal specified according to the transmission request message, when the third terminal is selected as the transmission source terminal; and
a second transmitting unit that specifies the internal identifier of the second terminal and transmits the received establishment request message to the second terminal, when the third terminal is selected as the transmission source terminal.

3. The apparatus according to claim 2, further comprising:
an identifier storage unit that can store the public identifier of the transmission source terminal and the internal identifier of a transmission destination terminal of the establishment request message, in association with each other; and
a storage unit that stores the public identifier of the third terminal and the internal identifier of the second terminal as the transmission destination terminal in the identifier storage unit, in association with each other, when the third terminal is selected as the transmission source terminal, wherein
the second transmitting unit obtains the internal identifier associated with the public identifier of the third terminal from the identifier storage unit, specifies the obtained internal identifier, and transmits the received establishment request message to the second terminal.

4. The apparatus according to claim 2, wherein
the first transmitting unit further transmits to the first terminal, the transmission request message to which the internal identifier of the second terminal is added, when the third terminal is selected as the transmission source terminal,
the second receiving unit receives from the third terminal, the establishment request message to which the internal identifier of the second terminal obtained from the transmission request message is added, and
the second transmitting unit obtains the internal identifier of the second terminal that is added to the establishment request message, specifies the obtained internal identifier, and transmits the received establishment request message to the second terminal.

5. The apparatus according to claim 2, further comprising:
a communication-information storage unit that stores communication information in which a communication identifier for identifying an established communication, and at least one of the public identifier and the internal identifier of a terminal that establishes the communication having the communication identifier are associated with each other; and
a third transmitting unit that transmits the communication information stored in the communication-information storage unit, to the plural terminals, wherein
the first receiving unit receives from the second terminal, the switching request message requesting switching the call counterpart of the third terminal that is one of terminals establishing the communication having the communication identifier that is selected by the second terminal by referring to the transmitted communication information, from the first terminal that is the other terminal establishing the communication, to the second terminal.

6. The apparatus according to claim 5, wherein the third transmitting unit transmits the communication information to a terminal to which the public identifier is assigned, the public identifier matching the public identifier of the terminal that establishes the communication having the communication identifier included in the communication information.

7. The apparatus according to claim 5, wherein the third transmitting unit transmits the communication information using a NOTIFY request according to a session initiation protocol (SIP).

8. The apparatus according to claim 5, further comprising:
a third receiving unit that receives an information request message requesting transmission of the communication information, wherein
the third transmitting unit further transmits the communication information to a terminal that requests the communication information, when receiving the information request message.

9. The apparatus according to claim 8, wherein the third receiving unit receives the information request message that is a SUBSCRIBE request requesting transmission of the communication information according to the SIP.

10. A communication control method executed in a communication control apparatus that controls communications among plural terminals including first, second, and third terminals that are connected through a network, the method comprising:
receiving from the second terminal a switching request message requesting switching of a call counterpart of the third terminal that establishes a communication with the first terminal, from the first terminal to the second terminal;
selecting one of the second terminal and the third terminal as a transmission source terminal that transmits an establishment request message requesting establishment of a communication between the second terminal and the third terminal, according to a predetermined rule, when receiving the switching request message; and
transmitting to the transmission source terminal, a transmission request message requesting transmission of the establishment request message.

11. A computer program product having a computer readable medium including programmed instructions for controlling communications among plural terminals including first, second, and third terminals, wherein the instructions, when executed by a computer, cause the computer to perform:
receiving from the second terminal a switching request message requesting switching of a call counterpart of the third terminal that establishes a communication with the first terminal, from the first terminal to the second terminal;
selecting one of the second terminal and the third terminal as a transmission source terminal that transmits an establishment request message requesting establishment of a communication between the second terminal and the third terminal, according to a predetermined rule, when receiving the switching request message; and
transmitting to the transmission source terminal, a transmission request message requesting transmission of the establishment request message.

12. A terminal device that is connected to plural external terminals and a communication control apparatus for controlling communications among the external terminals, through a network, the terminal device comprising:
a receiving unit that receives from the communication control apparatus, communication information including a communication identifier for identifying a communication established among the external terminals and terminal identifiers for identifying the external terminals that are establishing the communication having the communication identifier, in association with each other; and
a transmitting unit that transmits to the communication control apparatus, a switching request message requesting switching of one of the external terminals that are establishing the communication having the communication identifier selected by referring to the received communication information, to the terminal device.
